(19) United States
(12) Patent Application Publication
(10) Pub. No.: US 2024/0005278 A1
(43) Pub. Date: Jan. 4, 2024

(54) SYSTEM FOR GENERATING ASYNCHRONOUS ISSUE UPDATES FOR AN ISSUE TRACKING SYSTEM

(71) Applicants: Atlassian Pty Ltd, Sydney (AU); Atlassian Inc., San Francisco, CA (US)

(72) Inventors: David Wilson, Sydney (AU); Simon Stiefel, Brisbane (AU); Rayen Magpantay, Sydney (AU)

(21) Appl. No.: 17/855,416

(22) Filed: Jun. 30, 2022

(51) Int. Cl. G06Q 10/10

(52) U.S. Cl. CPC G06Q 10/103

(57) ABSTRACT

Embodiments include methods and systems for receiving a request for updates on a project managed by an issue tracking system and in response to receiving the request retrieving, from an issue tracking system, a set of user accounts assigned to the project and one or more issues assigned to respective user accounts. The methods can also include generating update requests that are associated with issues where each update request includes an option to provide input to the issue. Methods can include generating update summaries and causing a client application to display graphical icons corresponding to update summaries. In response to a selection of a particular graphical icon, methods can include causing the client application to display a second graphical interface comprising the set of update summaries for a particular user associated with the particular graphical icon.

### FIELD

The described embodiments relate to generating issue summaries for issues management by an issue tracking system and, in particular, to systems and methods for creating asynchronous updates for issues managed by an issue tracking system.

### BACKGROUND

Organizations are increasingly using various software products to facilitate communication and workflow for individuals and teams. Issue tracking software may be used to manage and track progress for various project development projects. While some traditional issue tracking software platforms are adapted for tracking major milestones for issues or tickets managed by the system, it can be difficult to share incremental progress with a larger team of users, particularly if the team of users are geographically distributed. Incremental updates are also difficult to collect and visualize given the limited display area and touch screen interface provided on many traditional mobile devices. The systems and techniques described herein are directed to a networked system of mobile devices that can be used to generate and aggregate progress on issues tracked by an issue tracking platform.

### SUMMARY

Embodiments are directed to computer-implemented methods that include receiving a request, from a client application operating on a first mobile device, for updates on a project managed by an issue tracking system, the request including a unique project identifier that is associated with the project at the issue tracking system. In response to receiving the request, the methods can include retrieving, from the issue tracking system, a set of user accounts assigned to the project and, using the set of user accounts, retrieving from the issue tracking system, one or more issues assigned to respective user accounts and associated with the project. The methods can also include generating, for each user in the set of user accounts, one or more update requests that are associated with issues that a respective user is assigned to, where each update request of the one or more update requests identifying an issue assigned to the user, and an option to provide user input to the issue and sending the one or more update requests to a respective mobile device associated with the respective user. In response to receiving one or more updates associated with the one or more update requests, the methods can include generating a set of update summaries including an update summary for each user in the set of user accounts, the update summary comprising an issue identifier for a respective issue and a user input to the update request. The methods can include causing the client application operating on the first mobile device to display a first graphical interface comprising graphical icons corresponding to update summaries in the set of update summaries and in response to a selection of a particular graphical icon, causing the client application to display a second graphical interface comprising the set of update summaries for a particular user associated with the particular graphical icon.

Embodiments are also directed to computer-implemented methods that include receiving a request for updates on issues managed by an issue tracking system from a client application operating on a first mobile device and, in response to receiving the request, retrieving one or more issues from the issue tracking system and identifying a user account associated with each issue of the one or more issues. The methods can include generating, for each issue of the one or more issues, an update request, each update request identifying an issue, a respective user account associated with the issue, and an option to provide user input to the issue and sending each update request to a respective mobile device associated with the respective user. In response to receiving updates associated with each update request, the methods can include generating a set of update summaries, including an update summary for each user account, the update summary comprising an issue identifier for a respective issue and a user input to the update request, and causing the client application operating on the first mobile device to display a first graphical interface comprising graphical icons corresponding to update summaries in the set of update summaries. The methods can also include, in response to a selection of a particular graphical icon, causing the client application to display a second graphical interface comprising the set of update summaries for a particular user associated with the particular graphical icon.

Embodiments are further directed to server systems that include a memory allocation defined by a data store, one or more executable assets, a working memory allocation, and a processor allocation configured to load the one or more executable assets from the data store into the working memory allocation to instantiate an instance of a client application on a mobile device. The processor can be configured to receive a request, from a client application operating on a first mobile device, for updates on issues managed by an issue tracking system. In response to receiving the request, the server system can retrieve, from the issue tracking system, one or more issues, generate, for each user in the set of user accounts, one or more update requests that are associated with issues that a respective user is assigned to, each update request of the one or more update requests identifying an issue assigned to the user, and an option to provide user input to the issue, and send the one or more update requests to a respective mobile device associated with the respective user. In response to receiving one or more updates associated with the one or more update requests, the server system can generate a set of update summaries, including an update summary for each user in the set of user accounts, the update summary comprising an issue identifier for a respective issue and a user input to the update request, and cause the client application operating on the first mobile device to display a first graphical interface comprising graphical icons corresponding to update summaries in the set of update summaries. In response to a selection of a particular graphical icon, the server system can cause the client application to display a second graphical interface comprising the set of update summaries for a particular user associated with the particular graphical icon.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example networked computer system in which various features of the present disclosure may be implemented;

FIG. 2 shows an example operation of an asynchronous update system;

FIG. 3A shows an example of a graphical user interface for generating update requests at a client application of a mobile device;

FIG. 3B shows an example of a graphical user interface for providing an update to an update request at an asynchronous update system;

FIG. 3C shows an example of a graphical user interface for viewing and interacting with updates received from the asynchronous update system;

FIG. 3D shows an example of a graphical user interface for viewing status updates managed by an asynchronous update system;

FIG. 4 shows an example process for requesting and reviewing status updates managed by an asynchronous update system;

FIG. 5 shows an example of a graphical user interface for providing an update to an update request at an asynchronous upstate system; and

FIG. 6 shows an example electrical block diagram of an electronic device that may perform the operations described herein.

While the invention as claimed is amenable to various modifications and alternative forms, specific embodiments are shown by way of example in the drawings and are described in detail. It should be understood that the drawings and detailed description are not intended to limit the invention to the particular form disclosed. The intention is to cover all modifications, equivalents, and alternatives falling within the scope of the present invention as defined by the appended claims.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to systems and methods for managing asynchronous updates for issues that are managed by an issue tracking system. The systems and methods can be implemented on client applications operating on mobile devices that are associated with registered users of the issue tracking system. The issue tracking system may manage projects, which may include one or more issues. The projects may have a defined workflow that includes various issues, which may need to be completed to progress through a project. Each issue may have associated issue data, which can include an issue identifier (e.g., issue serial number or ticket number), a title for the issue, a description of the issue, a start date, due dates, one or more tasks that need to be completed, users assigned to the issue and so on. Issue data may be stored at the issue tracking system and used to track progress of issues, user contributions to an issue, and so on. In some cases, as an issue is updated and/or completed, the issue management system may update the status of an issue and/or request input from other users.

The systems and methods described herein may allow users of the system to asynchronously update and review projects and issues managed by the issue tracking system. A first user may send a request for project updates using a client application operating on a first mobile device (or other device). The system may identify users associated with the project and send update requests to mobile devices (or other devices) associated with each user. The users may provide updates using their mobile device, for example, by inputting text, audio, video, or other inputs that are associated with a particular issue of the project. The system may receive the updates from the mobile devices and create a set of update summaries for the project. For example, an update summary may be generated for each issue and include a user's input to that issue. The set of update summaries may be sent to the mobile device of the first user. Accordingly, each user may be able to provide updates at different times and the first user may subsequently receive and be able to view all the updates associated with a particular project.

The system may identify a set of user accounts for requesting updates in a variety of ways. In some cases, the system may identify a set of users based on an individual user's association with a particular project. For example, a first user may request updates related to a particular project, for example by selecting that project in the client application on their mobile device. The client application may send an update request which includes a project identifier (e.g., project serial number, project name, or other identifier) to the issue tracking system. The issue tracking system may determine a set of issues that is associated with the project identifier. In some cases, these issues may be active issues and/or issues with a defined status, such as issues that have been modified or updated within a defined period, issues that are waiting review, and so on. The issue tracking system may also determine one or more users associated with each issue in the set. This may include analyzing issue data to identify a user that made the most recent update or change to an issue, identifying if input is required to an issue, and determining if the input is required from a particular user, and so on.

An update request may be sent for each issue to one or more of the identified users. In some cases, an update request may be sent for each issue in the set of identified issues. Accordingly, if some users are associated with multiple different issues, they may receive multiple update requests at their mobile device and have multiple options to respond to each update request. Accordingly, each update may be provided by various users of the system on an issue-by-issue basis. In some cases, the system may identify a single user account associated with each issue, for example, a user account associated with a user that is responsible for completing a current task for the issue. For this reason, the system may generate and send one update request for each issue in the set. However, in other cases, the system may generate and send update requests for a particular issue to multiple users. In these cases, if one of the multiple users responds to the update request, the system may notify the other users and/or remove the other update request.

In some cases, the system may identify a set of users based on a scheduled meeting. For example, the system may retrieve data from a calendar service associated with the first user account (e.g., via API calls to the calendar service) and identify a meeting that is scheduled for providing updates in relation to a specific project. The system may identify a set of users associated with the meeting and determine a set of issues for requesting updates based on the users and/or a project associated with the meeting. For example, the system may determine from the data retrieved from the calendar service that a meeting is associated with a particular project. Accordingly, the system may identify a set of issues that is associated with both the identified project and the user accounts that are associated with the meeting. In some cases, the system may identify a set of users based on data retrieved from a messaging platform, a video-conferencing platform, or other communication platform that is used to host meetings and/or facilitate communication between users. Alternatively, the system may identify a set of issues based on the user accounts and the first user account requesting the update, for example, without identifying a particular project. For example, the system may identify the set of issues based on issues with an active status and associated with the first user account and at least one other user account that was identified from the meeting invite.

In some cases, the system may identify a set of users based on a status of an issue at the issue tracking system and/or whether the issue tracking system indicates that an input is required to progress the issue. For example, the first user may generate an update request at the first client device for all open issues that the first user is associated with. The client device may send the request to the issue tracking system and the issue tracking system may identify issues that include both an open status and issues that are associated with a user identifier of the first user. In other examples, the client application may include a variety of filters/selection tools for generating update requests. In addition or as an alternative to generating update requests based on status, the filters/selection tools can include options for selecting particular users, due dates for a task or completion of an issue, alerts associated with an issue, timing of a last update, and/or any other suitable parameters.

The system may generate update requests for each issue and send one or more update requests to a mobile device (or other electronic device) of a user that the update is being requested from. Each update request may be displayed on the client application of the mobile device of the user and include information about the issue and an option to provide user input to the issue. In some cases, the option to provide user input may include an interface for entering text-based input. In other cases, the option to provide user input may include an interface (controls) for recording an audio-based update and/or a video-based update. In response to receiving user input, the input may be sent to the issue tracking system and be associated with the corresponding issue. Accordingly, the user update may be provided to the first user, who made the request, and be associated with the issue at the issue tracking system so that if other users access the issue, using the issue tracking system and/or other application, they can view any updates that have been provide as part of an update request.

In some cases, the options to provide user input can include a set of predefined responses that the user can select from. For example, the predefined response may include a “no updates” option, a “still working” option, a “please review” option, or any other suitable option. If a user selects one of these options on their mobile device, the system may automatically generate the update response in accordance with the selected option. In some cases, the predefined response may cause various actions by the system. For example, selecting a “please review” option may cause the issue tracking system to update a status of the issue, generate an alert for the reviewer, and/or take some other action. In some cases, the input option can be dynamically generated based on a status of the issue, content of the issue, one or more users associated with the issue, or based on other suitable parameters. For example, if an issue is behind schedule, the client application may include a first set of options and, if an issue is on track or ahead of schedule, the client application may include a different set of options.

In some cases, update responses, or other updates to an issue may be stored as part of the an update record that is associated with an issue. For example, the update response may be captured in a comment stream, comment archive, update log or other suitable data structure and may be viewed or accessed from the issue in the issue management system. In some cases, the update response may be chronologically organized. Additionally or alternatively, the update responses may be captured in a content collaboration platform, for example, in a document page associated with the issue. Accordingly, a user of the system may be able to access the documents page and view update requests and update responses for an issue or project.

In some cases, the update response may be used to advance issues through various states of a programmed workflow. For example, the issue tracking system may determine from an update response that an issue has progressed from a first stage to a second stage and update the issue in accordance with the update response. Accordingly, the update response may be used by the issue tracking system to automatically update and progress issue through a programmed workflow. In some cases, the update response may include input objects for setting a progress metric associated with the issue. For example, the update request may include an user interface object such as a slide bar that a user can select and move to designate a completion metric (e.g., percentage of completion) for the project. The completion metric may be used to generate a completion graphic in the update summary and/or update progress of the issue at the issue tracking system.

After receiving updates to the update request, the system can generate a set of updated summaries. In some cases, the update summaries can be organized by user accounts associated with a user who provided the update. For example, the system may generate an update summary for each user that provided updates. The update summary for each user can include updates related to each issue. The update summary may identify each issue, for example, by title or other issue identifier and include the update that was input by the respective user. In some cases, the client application on the first user device (e.g., requesting user) can receive the set up updates from the system and display the updates on a user-by-user basis. For example, the client application may display a set of avatars that corresponds to each user account that an update request was sent to. In response to the first user selecting an avatar, the client application can display the update summary for that user showing the issues that the user has provided updates for along with the updates.

The first user can view the text updates and/or listen to or view audio and video updates. In some cases, the client application may track whether a user has interacted with an update and update a view flag associated with the update. In some cases, the system may allow the first user, who is reviewing an update, to respond using comments, audio, video, or other inputs, which may be sent to the user who provided the update, and other users associated with the issue and/or the issue tracking system. In some cases, the first user may be able to select different users and view the updates provided by that user. The system may track progress of the viewed updates and indicate how many of the updates that the user has reviewed.

In some cases, the system may set time windows for receiving a response to update a request and/or for reviewing update summaries. For example, the first user may set a time window in the update request which defines when the updates need to be received by the system. In some cases, the system can collect updates on a rolling basis, but not send the update summaries to the first user's mobile device until expiration of the time period or until all updates have been received. Accordingly, this may allow the first user to view and respond to updates received at different times, within the time window, at once. In other cases, the system may update the first client application to indicate which updates have been received. In these examples, the system may simply indicate that an update has been received but may not provide the update until the expiration of the time period. In other cases, the system may send the updates to the first client device as they are received, and the first user can review the updates on a rolling basis.

If updates are not received at the expiration of the time window, the system may generate a reminder to send to client devices associated with the missing updates. The reminder may include a notification and/or a prompt to respond to the outstanding update request. In some cases, this notification may have a set of pre-generated responses that the user can select. In other cases, the system may indicate in the update summary that no response was received and/or prompt the first user to extend the time limit for responding.

The issue tracking system may update an issue in accordance with updates received from one or more users of the system. For example, the updates may become part of the issue data and can be viewed by users associated with a particular issue and/or project or viewed by other users of the system. In some cases, users may comment on or otherwise respond to an update, for example, at the issue tracking system and/or a mobile application for the issue tracking system. These responses may generate alerts to the user who provided the update and/or the first user who requested the update. In some cases, access to updates and/or the corresponding issue may be permission based. For example, the system may verify permission associated with a user account that is attempting to access a project, issue, and/or updates associated with an issue. In some cases, the permissions may be based on a user's role/relationship to an issue, which can be defined in their user account profile. For example, the user account profile for users assigned to work on an issue may include permissions that allow the users to access and modify an issue, whereas the user account profile for other users that are not directly associated with an issue may include only permissions to view the issue and/or comment on updates.

These and other features of an issue tracking system are described herein. While certain example application environments are used to illustrate the features of the event feed service, these are provided for example purposes only. Indeed, the user update services described herein may generate update summaries for, recommend item sources from, and display update summaries in numerous different types of software applications and/or services, including but not limited to messaging applications (e.g., instant message applications, email applications, group-messaging applications, etc.), wiki applications, sales management applications, project management applications, source code control applications (e.g., for managing, creating, and/or editing source code for computer programs, websites, etc.), human resources applications, or the like.

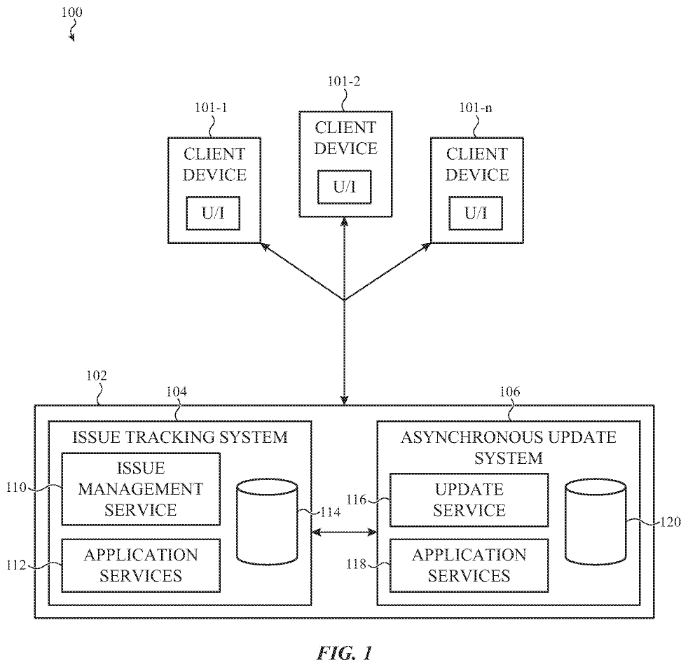

These and other embodiments are discussed below with reference to FIGS. 1-6. However, those skilled in the art will readily appreciate that the detailed description given herein with respect to these Figures is for explanatory purposes only and should not be construed as limiting.

FIG. 1 shows an example networked computer system 100 (also referred to as “system 100”) in which various features of the present disclosure may be implemented. The system 100 includes an application platform 102 and client devices 101 (101-1, . . . , 101-n) that communicate via a network (e.g., the Internet). The client devices 101 may be any suitable type of device, including but not limited to a desktop or laptop computer, tablet computer, mobile phone, personal digital assistant, smart device, voice-based digital assistant, or the like.

The application platform 102 may be or may include one or more servers, content stores (e.g., databases), communications systems, data structures, programs, or other components, systems, or subsystems that provide services described herein. The application platform 102 may include an issue tracking system 104 and an asynchronous update system 106.

The client application may be a dedicated application that is designed for use with a corresponding backend application. For example, an issue tracking service may include a backend system that tracks and manages issues and one or more client applications that interface with the backend system and provide user interaction schemes and/or Uls on different types of client devices. For example, a dedicated client application can include a mobile application that is configured to run a particular mobile software system. In other cases, a dedicated client application can include a desktop application that is configured to run on a particular desktop software system. Alternatively, the client application may be implemented using a mobile web browser or general web browser that is configured to communicate with and provide an interface for the backend application via web-based protocols such as JavaScript or other suitable web protocols.

The system 102 may be accessible by client devices operating either a dedicated client application or a web browser configured to interface with the system 102 via a web-based protocol. For example, one or more client devices can include a client application the communicates with the system 102 to retrieve and send data to the system 102 based on a user's inputs and/or interactions with the client application. In some cases, a client device may access the system 102 using a web-based browser application, which communicates with the system 102 to retrieve and send data to the system 102 based on a user's inputs and/or interactions with the client application.

The issue tracking system 104 may include an issue management service 110, one or more application services 112, and a data store 114. The application services 112 and data stores 114 may facilitate the creation, deletion, management, editing, serving, and/or other services related to the issues, content, and/or content items associated with that software application and stored in the data store 114. The application services 112 may also generate events or messages in response to changes or activity occurring with respect to the asynchronous update system 106. Data store 114 may be databases or other data storage resources that store content items and/or other data related to the issue tracking system 104. The issue tracking system 104 may be associated with dedicated servers or server systems. The issue tracking system 104 may also be implemented using a software as a service (SaaS) architecture which may be accessed by a client device 101 via a web browser or other similar client application.

The issue tracking system 104 tracks issues or discrete aspects of a development project or other process using tickets or an issue number. Information related to the various issues (referred to herein as “issue data”) may be stored in the data store 114. In general, issues are tracked along a workflow or set of issue states from initiation to resolution. Issue data may include various content including, for example, a user-generated description of an issue, issue status (e.g., closed, open, awaiting review), assignee, supervisor or reviewer, related user, issue urgency, issue age or pendency, images, links to code, and other issue-related content. Each issue and, in some cases each state, may be associated with a different assignee or user responsible for completing the issue or state. In some cases, issue data may include user-generated specifications of issues in computer code of software products. Issue data may be stored in the data store 114 as files, data structures, or the like.

Issues managed by the issue tracking system may be associated with a project, various users, and/or one or more teams or groups of users. For example, a project may include a set of issues and the issues may be organized based on a workflow and/or dependency of issues on each other. Accordingly, some issues may need to be addressed before other issues can be completed (or started). In some cases, issues may have one or more states (e.g., active, pending, not started, complete, and so on) and can be changed from a first state (e.g., pending) to a second state (e.g., active). In some cases, one or more users can change a state of an issue, which may cause an event communication to be sent to the event feed service. Accordingly, as issue states are changed, the event feed service may update feed items to reflect these changes.

The application services 112 of the issue tracking system 104 may facilitate content services related to the issues, including causing user interfaces of the issue tracking system to be displayed to a user on a client device 101, receiving user inputs relating to the creation and/or modification of issues (e.g., changing status, receiving content related to the issue and/or issue resolution, etc.), changes to issue status, changes to user assignments, and the like. The application services 112 may also send event notifications or other communications related to events (which also may be referred to as “event communications”) caused by activity related to the various issues being tracked by the issue tracking system 104.

The asynchronous update system 106 may include an update service 116, one or more application services 118 and a data store 120. The asynchronous update system 106 may communicate with one or more of the client devices 101 to create update requests for projects and/or issues managed by the issue tracking system 104 and send the update requests to other client devices 101. The asynchronous update service 106 may receive an update response from the client device 101, generate update summaries, and cause a requesting client device (e.g., client device 101-1) to display the update summaries.

The update service 116 may manage generating update requests and sending out the update requests. Instances of the update service 116 may be instantiated on the client device 101 to implement the functions of the asynchronous update system 106 at each of the client devices 101. Each instance of the update service 116 instantiated at the client device may also be referred to as a “client application,” which operates on a respective client device 101. In some cases, the functions provided by the client application may be based on a particular user account profile. For example, each client device 101 may be associated with a user account (e.g., via an authentication protocol such as single sign on). The user account may be managed by the issue tracking system 104 or other integrated system of the application platform 102 and define user roles such as a manager role, assignments to issues, roles for specific issues, reporting relationships, or other suitable parameters. In some cases, the assigned role (or other user parameters) may be used to configure which functions of the update service 116 or the application service 118 that a particular user may access. For example, the first client device 101-1 may be associated with a user-account that is assigned a manager role and the update service may enable functions of the update service 116 on the first client device based on that role. For example, the client application on the first client device 101-1 may allow a user to generate and send update requests to other users of the system 100.

The update service 116 may communicate, with other systems and/or services such as the issue tracking system 104, directory systems (e.g., including user profiles and other user account settings), calendar systems, email systems and so on using application programming interface (API) calls to request and/or retrieve data form these systems. For example, in response to receiving an update request from the first client device 101-1, which includes a project identifier, the update service 116 may send an API call to the issue tracking system to retrieve a set of issues and/or user accounts associated with the project identifier. The update service can use the retrieved issue and/or user account data to generate update requests for specific users and send those update requests to a client device (e.g., client device 101-2) associated with the users who the updated request is directed to.

The update service 116 may receive and/or request responses to the update request from the client device (e.g., client device 101-2). In response, the update service 116 may generate a set of issue summaries as described herein and send the set of issue summaries to the requesting client device 101-1. In some cases, the update service 116 (via an appropriate API call or other suitable communication protocol) may send data received from the client device in response to the update requests to the issue tracking system 104. The issue tracking system 104 may update a respective issue based on this data. Accordingly, the update service 116 may facilitate generating, sending, and receiving issue updates between the client device associated with various users and also ensure that the updated activity occurring between the client device 101 is updated at the issue tracking system 104.

The asynchronous update system 106 may also include other application services 118 that facilitate generating and receiving updates to projects and issues that are managed by the issue tracking system 104. For example, the application service 118 may manage avatars associated with various users of the system 100 and associate each avatar with updates received from a different client device 101. The avatars may be used to display update summaries and associated specific updates with a particular user. In some cases, the application services 118 may facilitate content services related to the issues, including causing user interfaces of the asynchronous update system 106 to be displayed to a user on a client device 101, receiving user inputs relating to updates to and/or modification of issues (e.g., changing status, receiving content related to the issue and/or issue resolution, etc.), changes to issue status, changes to user assignments, and the like. The application services 112 may also send event notifications or other communications related to events (which also may be referred to as “event communications”) caused by activity related to the various issues being tracked by the issue tracking system 104.

While issue tracking systems are used as example software applications, these are merely examples of software applications that may be used with event feed services described herein. Other types of software applications and/or content sources that may provide feed items and about which feed item source recommendations may be generated include, without limitation, collaborative document systems, codebase systems, messaging applications (e.g., instant message applications, email applications, group-messaging applications, etc.), wiki applications, sales management applications, project management applications, human resources applications, or the like.

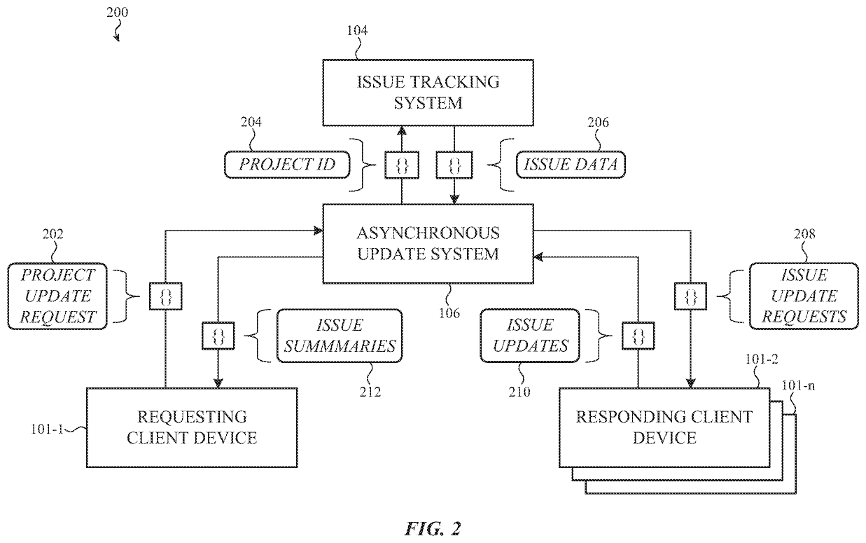

FIG. 2 shows an example operation 200 of an asynchronous update system 106 generating update summaries for display on a first mobile device 101-1 associated with a first user.

The first mobile device 101-1 may operate a mobile instance of a client application for the asynchronous update system 106 (also referred to as a “client application”). The client application may display a graphical user interface to a first user that is authenticated into the client application. The graphical user interface may be configured to receive an update request from the first user that is related to a project, issue, or set of issues that are managed by the issue tracking system 104. In some cases, the client application may include tools for configuring the request, which can include options for selecting a specific project, set of issues, user accounts, and so on for generating an update request.

In response to a user selecting an option to generate an update request, the first client application may configure a digital project update request 202 for sending to the asynchronous update system 106. The update request 202 may include an identifier of the project, a set of issues, a user account and/or user identifier of the first user, or other information which may be used by the asynchronous update system 106 to identify projects, issues, or users for associating with the update request. In some cases, the first user may input parameters that specify types of updates, activities, or information that the first user wants to include in the update request. For example, the first user may specify that they only want to receive updates for issues of a particular project that are behind a defined schedule. The client application generates the project update request 202, for example as an API call, and sends the project update request 202 to the asynchronous update system 106.

The asynchronous update system 106 may use the information received in the project update request to generate one or more queries to the issue tracking system 104. These queries may be used to retrieve data related to the project, set of issues, user accounts, or other parameters specified in the update request 202. For example, if the project update request 202 includes requests for all active issues associated with a particular project identifier 204, the asynchronous update system 106 may make one or more API calls to the issue tracking system 104 to retrieve data related to the particular project. These API calls may include the project identifier 204. The issue tracking system may use the project identifier 204 to retrieve issues for that project with the active status and return the corresponding information as issue data 206 to the asynchronous update system 106. The issue data 206 may include an issue identifier for each returned issue, a user identifier(s) for one or more users associated with the project, issue information (e.g. issue title, description of the issue, due dates, current phase/task of the issue, last change to the issue, any notifications associated with the issue, or other suitable information), and so on.

The asynchronous update system 106 may use the issue data to formulate one or more issue update requests 208 to client devices of users associated with the returned set of issue data 206. For example, asynchronous update system 106 may identify a user account for each issue and generate an update request 208 to a client device associated with the user account. In some cases, a single user may be identified as needing to provide multiple update requests for different issues. The asynchronous update system 106 may generate separate update requests 208 for each issue or generate a single update request 208 that uniquely identifies each issue and requests an update to each of the issues. The update request 208 may include the project identifier, a project title, or other suitable project information, an issue identifier for each issue, an issue title for each issue, or other suitable information. The asynchronous update system 106 may send each update request 208 to a client device associated with the user accounts identified for providing updates on the issue (e.g., responding client devices 101-2-101-n).

In response to receiving the update request 208 each client device 101 may display a graphical interface in a mobile client application of the asynchronous update system. The graphical interface may identify a particular issue and provide one or more options for responding to the issue as described herein. In response to a user of the client device inputting an update to the client device, the client application may generate an issue update 210 for sending to the asynchronous update system 106. The issue update 210 may include the issue identifier, issue information, and the update input by the user.

The asynchronous update system 106 may collect issue updates 210 for each issue request 208. In response to receiving the issue updates 210 from the responding client devices 101, the asynchronous update system 106 may generate a set of issue summaries 212 for sending to the requesting client device 101-1. The set of issue summaries 212, may identify each issue, include issue information, user account information for a responding user, and include the update. Additionally or alternatively, the asynchronous update system 106 may send issue data including the issue updates to the issue tracking system 104, which may update a corresponding issue in accordance with the responding client device update data 210.

In some cases, the project update request 202 may include a time window for receiving issue updates 210. The asynchronous update system 106 may wait until the time window expires to generate a response to the requesting client device 101-1. If not all responses are received within the time window, the asynchronous update system 106 may indicate which issues did not receive updates in the issue summaries. Additionally or alternatively, the asynchronous update system 106 may send another update request 208 for outstanding issues, an alert, or other notification to the client device corresponding to the outstanding issue.

In response to receiving the set of issue summaries 212, the requesting client device 101-1 may update the client application to indicate that the issue update summaries have been received. Additionally or alternatively, the client application may generate graphical interfaces for displaying the issue summaries on the requesting client device 101-1 as described herein.

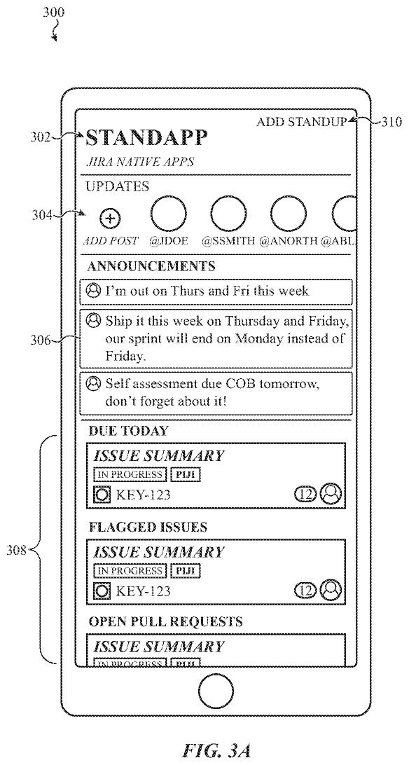

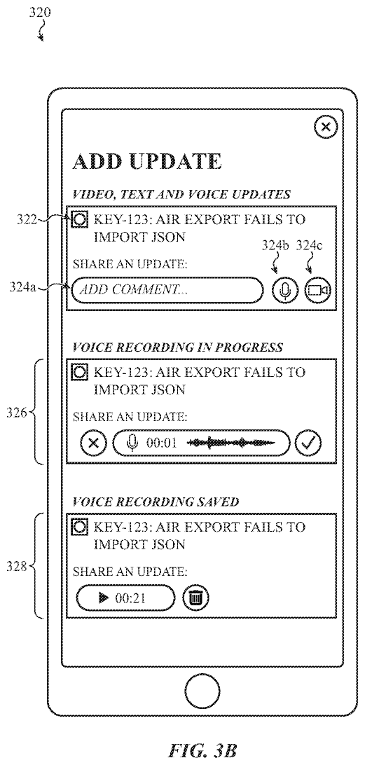

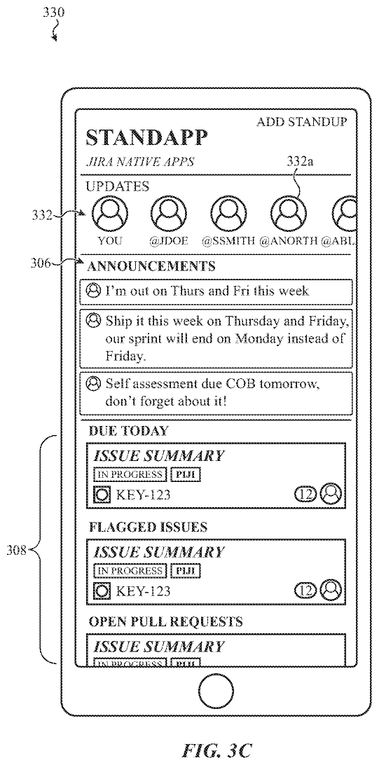

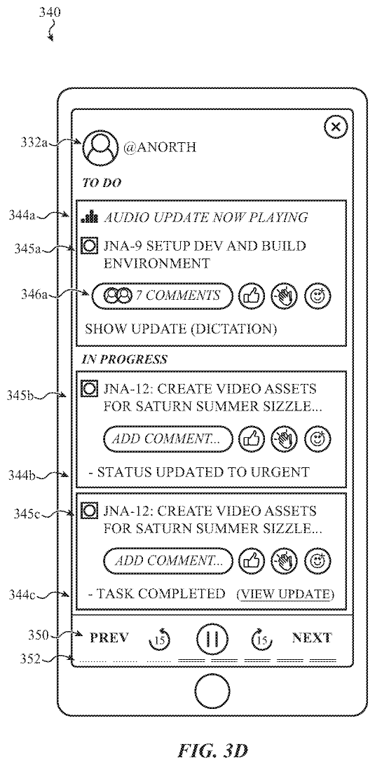

FIG. 3A shows an example of a graphical user interface 300 for generating update requests at a client application of a mobile device. The graphical user interface 300 may be generated for a particular project, meeting, or other update event. The graphical user interface 300 may include an identifier 302 of the project or meeting which uniquely identifies a project, set of issues, or reoccurring meeting between a group of users. The identifier 302 may be associated with a serial number or other identification that is used by the issue tracking system and asynchronous tracking system to uniquely identify a specific project or meeting.

In some cases, the graphical user interface 300 is generated in response to a user generating an update request. For example, the graphical user interface 300 may serve as a landing page for a particular update request and may be used to track and show progress of the update request to the requesting user in the client application operating on the first user's mobile device. In some cases, the graphical user interface 300 may include a selectable graphical object 310 for generating an update request. For example, in response to a user selection of the graphical object 310, the system may initiate an update request process as described herein. In some cases, in response to selecting the graphical object 310, the client application may display an interface for setting one or more parameters of the update request such as a time window for receiving update, what types of tasks, actions, or items the user would like to receive updates for, and or other suitable parameters for generating the update request as described herein. In some cases, the user generates a recurring update request, for example, a recurring update request may send requests for new updates on a weekly schedule, or any other defined schedule.

The graphical user interface 300 may also identify a set of users 304 that are associated with the project 302. For example, in response to a user opening the project 302 in the client application, the client device may query the issue tracking system to retrieve information associated with the project, such as the set of users 304, recent activity to the project, updates, notifications, or other information associated with the project. In some cases, the set of users 304, may be identified by icons and/or avatars that are associated with each user account. In some cases, the set of icons/avatars may be used to indicate a request status related to each user. For example, as shown in FIG. 3A, the icons may be unfilled when a particular user has not submitted an update request. When the system receives an update from a particular user, the system may update the corresponding icon to show an avatar or other graphical element associated with that user to indicate that their updates have been received.

Additionally or alternatively, the graphical user interface 300 may include additional information related to the project, meeting, and/or a set of users 304 assigned to the project. For example, the graphical user interface may include an announcement section 306, which may be used to provide updates to the set of users 304. In other examples, the graphical user interface 300 may include an issue tracking section 308, which may display issues that meet a defined criteria, such as issues that are due, or require some other input.

FIG. 3B shows an example of a graphical user interface 320 for providing an update to an update request at an asynchronous update system. The graphical user interface 320 may be displayed in a client application of a mobile device of users who have received one or more issue update requests. The graphical user interface 320 may be automatically generated in response to an update request from a first client device. For example, in response, to a first user generating an update request, the first client device may automatically cause the client devices associated with user account of the update request to generate the graphical user interface 320, which prompts users for inputs on issues associated with the project.

The graphical user interface 320 may display update requests for one or more issues in a list or other suitable format. In some cases, the graphical user interface 320 may only display a subset of the issue and a user may need to scroll or otherwise interact with the mobile device to view other issues of the set.

The graphical user interface 320 may include a name 322 or other identifier of the issue (e.g., by displaying a name of the issue “KEY-123: Air Export fails to import JSON”) and one or more options 324 for providing an update to the issue. For example, a first option 324a may include an active text field which the user can enter a text based response as an update to the issue. A second option 324b may include an option to provide an audio-based response. In response to the user selecting the second option 324b, the client application may display audio recording and playback controls 326 in the graphical user interface, which the user may use to record an audio-based update. A third option 324c may include an option to provide a video-based response. In response to the user selecting the third option 324c, the graphical user interface may display video recording and playback controls, which the user may use to record a video-based update. In response to entering a response, the client application may generate an issue update summary 328, which the user may be able to review prior to the client device sending the update to the asynchronous update system as described herein.

In some cases, input to the user interface 320 and including response to the one or more options 324 may be used to update the corresponding issue at the issue tracking system. For example, the client device may transmit received inputs to the issue tracking system, and the inputs may be analyzed by the issue tracking system and used to update an issue. For example, in response to an audio input, the system may convert the audio to transcribed input, which may be analyzed to determine updates to an issued, such as a change to a status, completion of a task and so on. The issue tracking system may use these analyzed updates to update an issue, for example, changing the status of the issue, indicating that a task has been completed and so on. Accordingly, user responses to update request may also be used by the system to automatically update the corresponding issue at the issue tracking system.

FIG. 3C shows an example of a graphical user interface 330 for viewing and interacting with updates received from the asynchronous update system. The graphical user interface 330 may correspond to a particular project or meeting and be used as a landing page for displaying updates to a requesting user in the client application on their mobile device. The graphical user interface 330 may include a set of icons 332 that corresponds to user accounts that are associated with a project or meeting and/or user accounts that updates have been requested for. As described herein, the icons may be populated with an avatar, picture of the user, or other graphical indications after receiving an issue update from the respective user. The graphical user interface 330 may also include an announcement section 306, as described herein.

The graphical user interface 330 may be displayed by the client application of the first user's mobile device (e.g., the requesting user) and/or by client applications of other users associated with the project (e.g., responding users). In some cases, the permissions and/or tools provided by the graphical user interface may be dependent on permissions associated with each user's account. For example, the first user's account may be assigned a project manager role and the client application of the asynchronous update system may include controls in the client application for generating additional update requests, updating the announcement section 306, and/or options to respond to received updates.

In some cases, the system may organize the received updates based on the users who provided the update, as described herein. The graphical user interface 330 may use the set of icons/avatars 332 to display updates related to a respective user. For example, in response to a selection of a first avatar 332a, the client application may display a second graphical user interface 340 as shown in FIG. 3D. The second graphical user interface 340 may display an update summary that includes issue updates 344 from a first user associated with the first avatar 332a. For example, a first issue update 344a may include an audio update, which the user may listen to or view a transcript of. The update summary may also include an issue identifier 345a (e.g., “JNA-9 Setup dev and build environment”) and provide an option 346a to comment on the update. In this case, the issue and/or update may include one or more comments to the issue and the option 346a to view the view the comments. Additionally or alternatively, the first issue update 344a may include one or more options for responding to the update. For example, the first user may enter a comment in the option 346a and/or select a predefined response (e.g., e.g., thumbs ups, which may indicate approval of the update and cause a status of the issue to change in the issue tracking system). If a user selects one or the options and/or provides other input to the update, the client device may send the response, a notification, or other alert to the user who made the update and/or other users associated with the issue and/or project. In some cases, the client application may also update the issue tracking system based on a response to an update.

The second graphical user interface 340 may display additional issue updates that are associated with the user 332a, such as issue updates 344b and 344c. In some cases, in response to the first user viewing all the updates associated with a particular user, the system may display a graphical user interface for another user and the one or more updates provided by that user.

Additionally or alternatively, the graphical user interface 340 may include navigation controls 350 for navigating between updates for different users. The navigation controls 350 may include graphical interface elements and/or be gesture based. For example, if the first user swipes to the left or selects an arrow on the right side of the update summary, the client application may display an update summary for a next user in the set of users. If the first user swipes to the right or selects an arrow on the left side, the client application may display an update summary for a previous user in the set of users. The client application may display a previous or next update summaries based on the ordering of the user avatars 332 in the graphical user interface 330 (shown in FIG. 3C). For example, the update summaries may be advanced in the same order as the order the avatars 342 were displayed in the graphical user interface 330. In some cases, the navigation can occur directly for one update summary to the next. Gestures indicating a first direction advances through the avatars and/or corresponding update summaries in a first progression and another gesture indicating an opposite direction to the first direction advances through the order in the opposite progression. For example, as a user swipes, an animation may be displayed showing the previous set of update summaries being transitioned off the screen and the next set of update summaries being transitioned onto the screen.

In some cases, the second graphical user interface 340 may include a progress indicator 352, which may indicate how many of the update summaries in the set of update summaries have been viewed. For example, the progress indicator 352 may indicate how many users' updates have been viewed (e.g., using a first graphic) and how many users' updates have not been viewed (e.g., using a second different graphic).

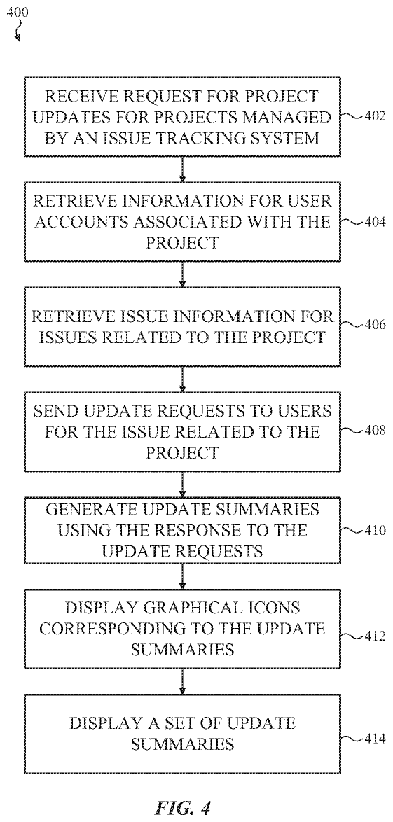

FIG. 4 shows an example process 400 for requesting and reviewing status updates managed by an asynchronous update system. The process 400 can be performed by the systems described herein.

At operation 402 the process 400 can include receiving a request for project updates managed by an issue tracking system. The request may be received at a first client application operating on a mobile device associated with a first user. The request may identify a particular project, issue, or set of issues, for example by including a project name or other project or issue identifier. In response to receiving the update request, the first client application may generate one or more API requests (or other suitable request) to the asynchronous update system that includes a project identifier, which may be used to retrieve project and/or issue data from an issue tracking system. In some cases, the API request may include a user identifier of the first user who created the update request and a role assigned to the first user. The first user identifier may be used to generate issue update requests to other users, such as identifying the first user as requesting the updates.

In some cases, the project update request may include additional parameters such as a time window associated with the request. The time window may define a time for receiving updates from the request users and may trigger additional actions in response to the expiration of the time window. For example, in some cases the asynchronous update system may collect updates related to a specific project request and, when the time window expires, generate the set up update summaries and send the update summaries to the client application of the first user's mobile device. In other cases, if the time window expires and the asynchronous update system has not received responses to all the requests, the update system may take some other action such as sending a notification to the user devices associated with the outstanding request and/or prompting those users to request more time or enter some other response.

In other cases, the system can request updates based on other factors besides a specific project. For example, the first client application may provide options for allowing the first user to enter specific users to receive updates from, for example, the first user may manually select one or more users for the system to generate update requests. In other cases, the system may allow the first user to enter issues and/or projects with a specific status, for example, the first user may generate update requests for issues with an active or awaiting review status. In other cases, the system may generate updates based on calendar information associated with the first user account. For example, the system may identify meetings from the first user's calendar profile, for example, by accessing a calendar application. The system may identify a set of users from a scheduled meeting (e.g., user accounts invited to the meeting) and/or projects associated with a particular meeting and generate the update request to the asynchronous update system using the information retrieved from the calendar application (e.g., via one or more API requests).

At operation 404, the process 400 can include retrieving information for user accounts associated with the project. The asynchronous update system may receive the update request from the first client application and retrieve information related to the project, issues, and/or users identified in the update request. For example, the asynchronous update system may generate one or more API calls to the issue tracking system that include a project identifier, issue identifiers, and/or user account identifiers. The issue tracking system may use this information to retrieve user data associated with an update request. For example, if the update request included a project identifier, the issue tracking system may use the project identifier to determine a set of user accounts assigned to the project. The issue tracking system may return this data to the asynchronous update system as a response to the API call(s).

At operation 406, the process 400 can include retrieving issue information for issues related to the project. The asynchronous update system may use the project identifier and/or user account data to retrieve issue data related to a project. For example, the API calls to the issue tracking system may include a request to return issue data (e.g., issue identifier, issue title, description, current status, and so on). The issue tracking system may use the project identifier and/or user data to identify a set of issues that is associated with the project. For example, if the update request from the first client device request updates for all active issues associated with a specific project, the asynchronous update system may generate an API call that identifies a specific project and includes a request for issue and user data for issues associated with the project that have an active status. In other cases, that asynchronous update system may generate API calls based on parameters in the update request from the first client applications, such as issues with recent updates, issues awaiting review, issues with outstanding deadlines, issues with a particular urgency, or any other suitable parameter.

At operation 408, the process 400 can include sending update requests to a user for the issues related to the project. The asynchronous update system may generate requests to client devices associated with users associated with the issues identified in operations 404 and 406. For example, the asynchronous update system may identify a particular user account for each issue returned from the issue tracking system. The user account may be based on a current status of the issue, for example, the user account may be identified for a user that is responsible for completing a current task. In some cases, the asynchronous update system may generate an issue update request to a particular user for each issue. In other cases, the asynchronous update system may identify multiple user accounts that are associated with a particular issue and generate an update request to each of these users. The update request, may cause display of a prompt for an update on a respective client device (e.g., graphical user interface 320 shown in FIG. 3B). In some cases, the system may receive and use updates from each user for a particular issue, and accordingly, have multiple updates for a single issue. In other cases, the system may only use a single update for a particular issue (e.g., the first update received from one of the requested users) and/or notify the other requested users that the update has been received.

At operation 410, the process 400 can include generating update summaries using the response to the update requests. In response to receiving responses from client devices associated with the user accounts of the issue update requests, the asynchronous update system may generate update summaries for sending to the first client application. Each update summary may identify a particular issue (e.g., issue name, serial/ticket number, etc.), include issue information (e.g., description, current status, users' accounts associated with the issues, due dates, urgency, and so on) and the update provided by the requested users. The update may be attached as a media files, for example in the case of audio or video updates, the update summary may include the recorded audio and/or video file.

The system may generate an update summary for each received update and associate each update summary with a user account of the user who provided the update. If an update is not received, the system may generate a summary that indicates that no update was received and provide an option for the first user to send a reminder, notification, message, or other communication to the mobile device of the respective user. In some cases, the asynchronous update system may generate and send a set of update summaries after the expiration of a time window or receiving a response to each update request. In other cases, the asynchronous update system may generate and send the update summaries to the first client application as they are received.

At operation 412, the process 400 can include displaying graphical icons corresponding to the update summaries. In response to receiving update summaries from the asynchronous update system, the client application may display graphical icons corresponding to the received update summaries. For example, the first client application may display a set of graphical icons corresponding to each user account who was sent an update request. When the update requests are sent and prior to receiving an update, the first client device may display the icons using a first scheme to indicate the request has been sent, but no response has been received. In response to receiving one or more update summaries from a user, the first client device may update the icon to display an icon using a second scheme indicating that updates have been received from that user. For example, the first scheme may include an icon that identifies a user account (e.g., name of the user), and displays a blank space that can be filled in with an avatar or other graphic (e.g., graphical user interface 300 shown in FIG. 3A). The second scheme may include populating the blank space for the corresponding user with the particular avatar or other graphic associated with that user account (e.g., graphical user interface 330 show in FIG. 3C). Accordingly, the display schemes used by the first client application may indicate to the first user which update summaries are ready for viewing.

At operation 414, the process 400 can include displaying a set of update summaries. In response to the first user selecting an icon corresponding to a particular user, the first client application may cause the client device to display the update summary for that user. The update summary may include each issue that the user provides and/or was requested to provide an update along with the update (e.g., text, audio, video, or update based on a selected predefined response as described herein). In response to a user viewing or otherwise interacting with a particular update, the client device may indicate that the particular update was viewed, which may also trigger the issue tracking system to be update and/or a notification to the corresponding user that the update was viewed. If the first user responds to or otherwise interacts with the update, the first client application may cause those inputs to the updates at the issue tracking system and/or notify the corresponding user or other users associated with the issue.

In response to the first user viewing each update for a particular user, the client application may cause a next set of updates associated with a different user to be displayed by the first client application. Alternatively, the first client application may include navigation controls, which the first user can use to view update summaries of different users.

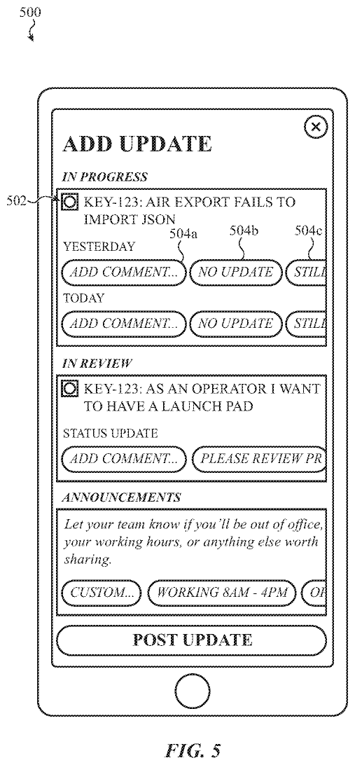

FIG. 5 shows an example of a graphical user interface 500 for providing an update to an update request at an asynchronous update system. The graphical user interface 500 may include pre-defined responses 504 to a particular update request. The graphical interface 500 may include an issue identifier 502, which can be a name, serial number, or other information used to identify the particular issue that an update is being requested for. The predefined responses 504 can be displayed as graphical icons in the user interface 500 and each may be associated with a specific response to the corresponding issue request.

A first predefined response 504a may cause an input interface to open and allow a user to enter text, audio, video, or other customized responses to the updated request. A second predefined response 504b may indicate that there are no updates and, in response to a selection of the second predefined response 504b, the system may generate an issue response indicating that there are not updates at this time. A third predefined response 504c may indicate that an issue is still in progress and, in response to a selection of the third predefined response, the system may generate an issue response indicating that the particular user is still working on the issue. Accordingly, each predefined response may be associated with a particular action.

In some cases, the predefined responses may be dynamically generated based on the issue data and or content associated with the issue request. For example, if the issue is behind schedule, the system may generate a first set of predefined responses and, if the issue is on time, the system may generate a different set of predefined responses. In other cases, if the issue has a particular status, for example awaiting review, the predefined response may be actions such as approving the issue, need more time to review, or questions about the issue. Accordingly, the predefined response may be different based on the issue, information associated with an issue, a status of an issue and so on.

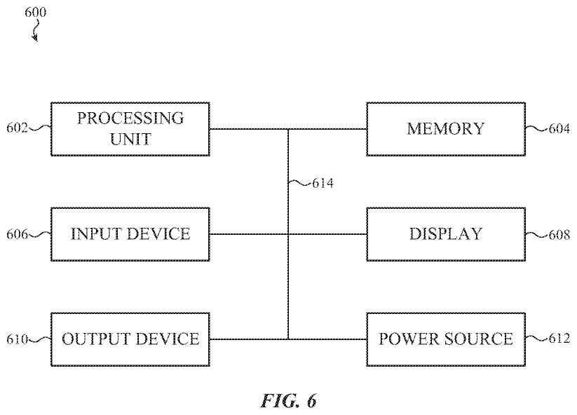

FIG. 6 shows an example electrical block diagram of an electronic device that may perform the operations described herein. The electronic device 600 may in some cases take the form of any of the electronic devices described with reference to FIGS. 1-5, including client devices, and/or servers or other computing devices associated with the system 100. The electronic device 600 can include one or more of a processing unit 602, a memory 604 or storage device, input devices 606, a display 608, output devices 610, and a power source 612. In some cases, various implementations of the electronic device 600 may lack some or all of these components and/or include additional or alternative components.

The processing unit 602 can control some or all of the operations of the electronic device 600. The processing unit 602 can communicate, either directly or indirectly, with some or all of the components of the electronic device 600. For example, a system bus or other communication mechanism 614 can provide communication between the processing unit 602, the power source 612, the memory 604, the input device(s) 606, and the output device(s) 610.

The processing unit 602 can be implemented as any electronic device capable of processing, receiving, or transmitting data or instructions. For example, the processing unit 602 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 600 can be controlled by multiple processing units. For example, select components of the electronic device 600 (e.g., an input device 606) may be controlled by a first processing unit and other components of the electronic device 600 (e.g., the display 608) may be controlled by a second processing unit, where the first and second processing units may or may not be in communication with each other.

The power source 612 can be implemented with any device capable of providing energy to the electronic device 600. For example, the power source 612 may be one or more batteries or rechargeable batteries. Additionally or alternatively, the power source 612 can be a power connector or power cord that connects the electronic device 600 to another power source, such as a wall outlet.

The memory 604 can store electronic data that can be used by the electronic device 600. For example, the memory 604 can store electronic data or content such as, for example, audio and video files, documents and applications, device settings and user preferences, timing signals, control signals, and data structures or databases. The memory 604 can be configured as any type of memory. By way of example only, the memory 604 can be implemented as random access memory, read-only memory, Flash memory, removable memory, other types of storage elements, or combinations of such devices.

In various embodiments, the display 608 provides a graphical output, for example associated with an operating system, user interface, and/or applications of the electronic device 600 (e.g., a chat user interface, an issue-tracking user interface, an issue-discovery user interface, etc.). In one embodiment, the display 608 includes one or more sensors and is configured as a touch-sensitive (e.g., single-touch, multi-touch) and/or force-sensitive display to receive inputs from a user. For example, the display 608 may be integrated with a touch sensor (e.g., a capacitive touch sensor) and/or a force sensor to provide a touch- and/or force-sensitive display. The display 608 is operably coupled to the processing unit 602 of the electronic device 600.

The display 608 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 608 is positioned beneath and viewable through a cover that forms at least a portion of an enclosure of the electronic device 600.

In various embodiments, the input devices 606 may include any suitable components for detecting inputs. Examples of input devices 606 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 606 may be configured to detect one or more particular types of input and provide a signal (e.g., an input signal) corresponding to the detected input. The signal may be provided, for example, to the processing unit 602.

As discussed above, in some cases, the input device(s) 606 include a touch sensor (e.g., a capacitive touch sensor) integrated with the display 608 to provide a touch-sensitive display. Similarly, in some cases, the input device(s) 606 include a force sensor (e.g., a capacitive force sensor) integrated with the display 608 to provide a force-sensitive display.

The output devices 610 may include any suitable components for providing outputs. Examples of output devices 610 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 610 may be configured to receive one or more signals (e.g., an output signal provided by the processing unit 602) and provide an output corresponding to the signal.

In some cases, input devices 606 and output devices 610 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 602 may be operably coupled to the input devices 606 and the output devices 610. The processing unit 602 may be adapted to exchange signals with the input devices 606 and the output devices 610. For example, the processing unit 602 may receive an input signal from an input device 606 that corresponds to an input detected by the input device 606. The processing unit 602 may interpret the received input signal to determine whether to provide and/or change one or more outputs in response to the input signal. The processing unit 602 may then send an output signal to one or more of the output devices 610, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

Example computing resources or appliances that may be configured to perform the methods described herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed for leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated for leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A computer-implemented method comprising:
receiving a project update request, from a client application operating on a first mobile device, the project update request including a unique project identifier that is associated with a project managed by an issue tracking system;
in response to receiving the request:
retrieving, from the issue tracking system, a set of user accounts assigned to the project;
using the set of user accounts, retrieving from the issue tracking system, one or more issues assigned to respective user accounts and associated with the project;
generating, for each user in the set of user accounts, one or more update requests that are associated with issues that a respective user is assigned to, each update request of the one or more update requests identifying an issue assigned to a user and an option to provide user input to the issue; and
transmitting the one or more update requests to a respective mobile device associated with the respective user; and
in response to receiving one or more updates associated with the one or more update requests:
generating a set of update summaries including an update summary for each user in the set of user accounts, the update summary comprising an issue identifier for a respective issue and a user input to an update request;
causing the client application operating on the first mobile device to display a first graphical interface comprising graphical icons corresponding to update summaries in the set of update summaries; and
in response to a selection of a particular graphical icon, causing the client application to display a second graphical interface comprising the set of update summaries for a particular user associated with the particular graphical icon.

2. The computer-implemented method of claim 1, wherein the option to provide the user input to the issue includes at least one of a first option to input a text update, a second option to input an audio update, and a third option to input a video update; and
in response to receiving an update to the issue, causing the issue tracking system to associate the update with the issue.

3. The computer-implemented method of claim 1, wherein the option to provide the user input to the issue causes an instance of the client application operating on the respective mobile device to display one or more graphical icons in the update request, the one or more graphical icons each comprising a predefined response that when selected causes the issue to be updated at the issue tracking system in accordance with the selected predefined response.

4. The computer-implemented method of claim 1, wherein:
the request for the one or more updates comprises a time parameter that defines a time window for receiving the one or more updates to the one or more update requests; and
in response to expiration of the time window, generating the set of update summaries.

5. The computer-implemented method of claim 4, further comprising, in response to the expiration of the time window:
determining update requests of the one or more update requests that have not received a response from the respective user; and
sending a notification associated with the update requests that have not received the response to client devices associated with respective users.

6. The computer-implemented method of claim 1, wherein the particular user is a first particular user and further comprising:
in response to determining that the set of update summaries for the first particular user was displayed by the first mobile device, causing the client application to display a third graphical interface comprising the set of update summaries for a second particular user.

7. The computer-implemented method of claim 6, wherein:
in response to sending the one or more update requests, the client application displays the graphical icons on the first mobile device according to a first scheme indicating that no update has been received; and
in response to receiving an update corresponding to the update request of the one or more update requests, the client application displays a respective graphical icon according to a second scheme indicating that the update has been received.

8. The computer-implemented method of claim 1 wherein the graphical icons each comprise an avatar corresponding to a user associated with a respective update summary.

9. The computer-implemented method of claim 1, further comprising, in response to receiving an update for each of the one or more update requests, causing the first mobile device to output a notification indicating that the update summaries are complete.

10. A computer-implemented method comprising:
receiving a request for updates on issues managed by an issue tracking system from a client application operating on a first mobile device;
in response to receiving the request:
retrieving one or more issues from the issue tracking system;
identifying a user account associated with each issue of the one or more issues;
generating, for each issue of the one or more issues, an update request, each update request identifying an issue, a respective user account associated with the issue and an option to provide user input to the issue; and
sending each update request to a respective mobile device associated with a respective user;
in response to receiving updates associated with each update request:
generating a set of update summaries including an update summary for each user account, the update summary comprising an issue identifier for a respective issue and a user input to the update request;
causing the client application operating on the first mobile device to display a first graphical interface comprising graphical icons corresponding to update summaries in the set of update summaries; and
in response to a selection of a particular graphical icon, causing the client application to display a second graphical interface comprising the set of update summaries for a particular user associated with the particular graphical icon.

11. The computer-implemented method of claim 10, wherein:
the request for updates on issues managed by the issue tracking system comprises a project identifier that is associated with a project at the issue tracking system; and
retrieving the one or more issues from the issue tracking system comprises sending an application programming interface (API) call to the issue tracking system comprising the project identifier.

12. The computer-implemented method of claim 11, wherein identifying a user account associated with each issue of the one or more issues, comprises receiving a set of user accounts from the issue tracking system in response to the API call, the set of user accounts associated with the project identifier.

13. The computer-implemented method of claim 10, wherein:
the request for the one or more updates comprises a time parameter that defines a time window for receiving the one or more updates to the one or more update requests; and
generating the set of update summaries comprises waiting until an expiration of the time window.

14. The computer-implemented method of claim 13, wherein in response to the expiration of the time window:
determining update requests that have not received a response from a respective user account; and
sending a notification to a client device of the respective user account, the notification indicating that the response to an update request is required.

15. The computer-implemented method of claim 13, wherein in response to the expiration of the time window:
the graphical icons are a first set of graphical icons;
the first set of graphical icons corresponds to received update summaries, each comprising an avatar corresponding to a user associated with a respective update summary;
determining a set of user accounts that have not responded to the one of more of the update requests; and
displaying a second set of graphical icons corresponding to the set of user accounts that have not responded to the one of more of the update requests.

16. A server system comprising:
a memory allocation defined by:
a data store;
one or more executable assets; and
a working memory allocation; and
a processor allocation configured to load the one or more executable assets from the data store into the working memory allocation to instantiate an instance of a client application on a mobile device and configured to:
receive a request, from a client application operating on a first mobile device, for updates on issues managed by an issue tracking system;
in response to receiving the request:
retrieve from the issue tracking system, one or more issues;
generate, for each user in a set of user accounts, one or more update requests that are associated with issues that a respective user is assigned to, each update request of the one or more update requests identifying an issue assigned to a user and an option to provide user input to the issue; and
send the one or more update requests to a respective mobile device associated with the respective user;
in response to receiving one or more updates associated with the one or more update requests:
generate a set of update summaries including an update summary for each user in the set of user accounts, the update summary comprising an issue identifier for a respective issue and a user input to an update request;
cause the client application operating on the first mobile device to display a first graphical interface comprising graphical icons corresponding to update summaries in the set of update summaries; and
in response to a selection of a particular graphical icon, cause the client application to display a second graphical interface comprising the set of update summaries for a particular user associated with a particular graphical icon.

17. The server system of claim 16, wherein:
the request for updates on issues managed by the issue tracking system, comprises receiving a project identifier;
determining a set of user accounts assigned to a project, comprises sending an application programming interface (API) call to the issue tracking system, the API call including the project identifier; and
use the set of user accounts to retrieve one or more issues assigned to respective user accounts of a set of users and associated with the project identifier.

18. The server system of claim 17, wherein:
the request for updates on issues managed by the issue tracking system, comprises receiving a meeting identifier associated with a scheduled meeting associated with the first mobile device;
determining the set of user accounts assigned to the project comprises sending an application programming interface (API) call to a calendar application, the API call including the meeting identifier; and
use the set of user accounts to retrieve one or more issues assigned to respective user accounts of the set of user accounts and associated with the meeting identifier.

19. The server system of claim 16, wherein the request for updates on the issues managed by the issue tracking system comprises a set of user accounts selected at the first client application.

20. The server system of claim 16, wherein:
the request for one or more updates comprises a time parameter that defines a time window for receiving the one or more updates to the one or more update requests; and
in response to expiration of the time window, the processor allocation is configured to generate the set of update summaries.
